(19) United States
(12) Patent Application Publication
(10) Pub. No.: US 2025/0183700 A1
(43) Pub. Date: Jun. 5, 2025

(54) GRID POWER LOSS DETECTION TECHNIQUE

(71) Applicant: Savant Systems, Inc., Hyannis, MA (US)

(72) Inventors: Nicole Madonna, San Francisco, CA (US); Jon R. Magnussen, Barrington, RI (US); Chris Tang, Vancouver, WA (US); Eric Batista, Berkley, MA (US); Timothy R. Locascio, Osterville, MA (US); Siegmar K. Eschholz, Southwest Harbor, ME (US)

(21) Appl. No.: 18/966,254

(22) Filed: Dec. 3, 2024

Related U.S. Application Data
(60) Provisional application No. 63/605,997, filed on Dec. 4, 2023.

(51) Int. Cl. H02J 9/06

(52) U.S. Cl. CPC H02J 9/06

(57) ABSTRACT

A technique monitors and detects a loss of utility power supplied by a main utility grid so that power modules of a virtual critical load panel (vCLP) may shed non-critical loads substantially before a battery inverter switches to backup power, grid detection module of the vCLP may be configured with profiles of industry standard power ranges utilized by a plurality of battery inverters to monitor and detect the loss of the utility power as an indication to switch to the backup power. The grid detection module employs the profiles in a manner that not only enables monitoring and detection of the loss of utility power but also enables shedding of the non-critical loads of the vCLP earlier than the switch to the backup power by the inverters.

### CROSS-REFERENCE TO RELATED APPLICATION

The present application claims the benefit of U.S. Provisional Patent Application Ser. No. 63/605,997, which was filed on Dec. 4, 2023, by Nicole Madonna et al. for GRID POWER LOSS DETECTION TECHNIQUE, which is hereby incorporated by reference.

### BACKGROUND

### Technical Field

The present disclosure relates generally to the field of electric power and, more specifically, to a system and technique for managing electric power consumption of loads in a premise.

### BACKGROUND INFORMATION

Backup or alternate local power system sources (local power sources), such as batteries using inverters, are often commercially locally deployed by customers or users of premises in a variety of types and sizes. However, the total power capacity of such local power sources is usually less (smaller) than the amount of power (energy) that a premise, such as a home or place of business, may typically consume. Therefore, during a switchover of power from a public utility to the local power source using a transfer switch and inverters, there is a need to prevent an overload of the local power source (i.e., avoid tripping an overload breaker) while also minimizing power interruption during the switchover. However, existing load management solutions typically require advanced notice that a battery inverter is switching to a battery for backup power in response to a public utility (grid) power shutdown to avoid power interruption. In addition, the inverters and transfer switches used to affect the switchover have differing switching times that vary by make and model further complicating accurate timing of the notice. Such timely notice enables reliable shedding of loads before (or at substantially the same time as) the battery inverter supplies the backup power to satisfy seamless power switchover while avoiding overload of the local power source. However, many inverters do not provide such timely notice.

### BRIEF DESCRIPTION OF THE DRA WINGS

The above and further advantages of the embodiments herein may be better understood by referring to the following description in conjunction with the accompanying drawings in which like reference numerals indicate identically or functionally similar elements, of which:

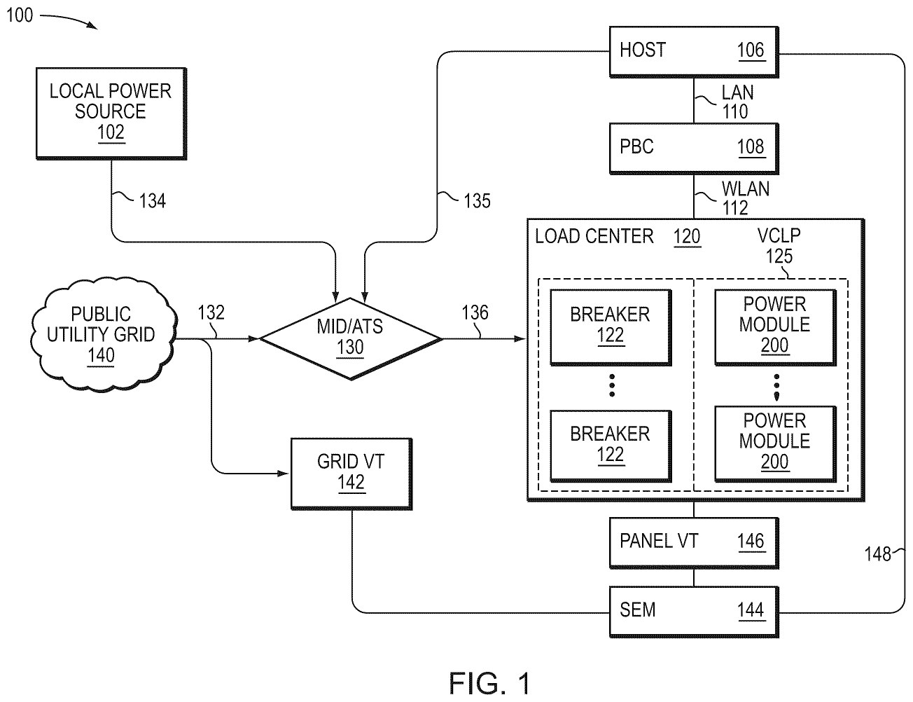

FIG. 1 illustrates an exemplary deployment of a flexible load management (FLM) system within a premise;

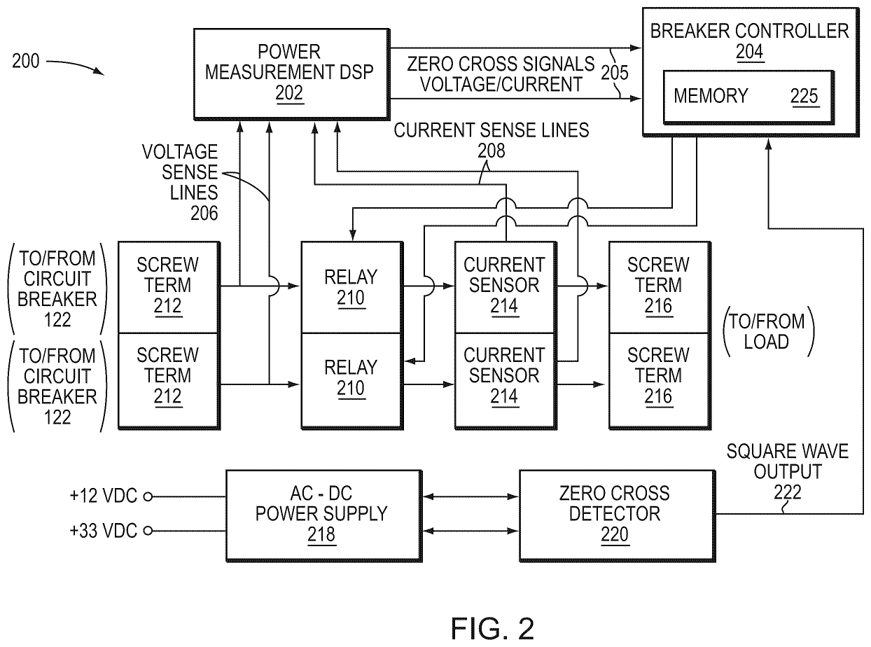

FIG. 2 is a block diagram of a power module of the FLM system;

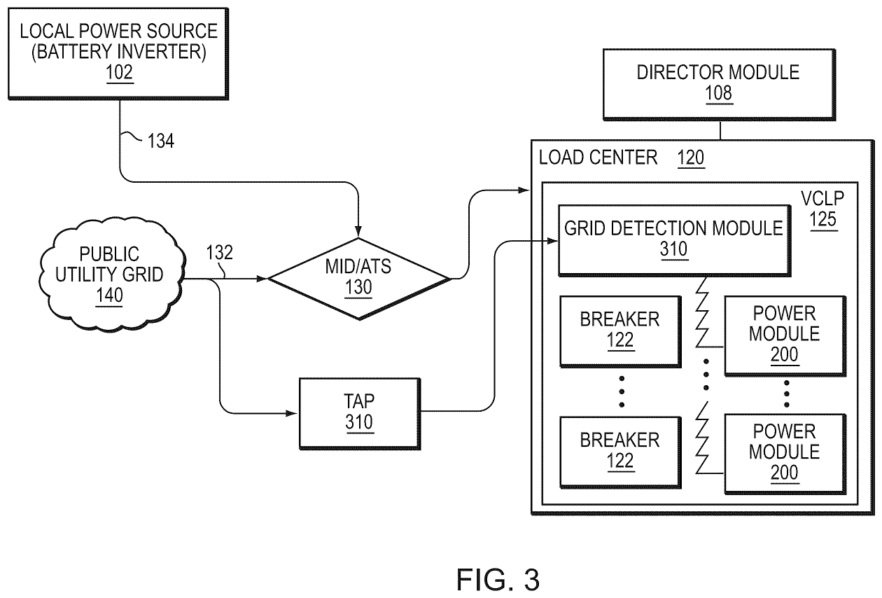

FIG. 3 illustrates an exemplary deployment of a grid power loss detection technique within the FLM system; and

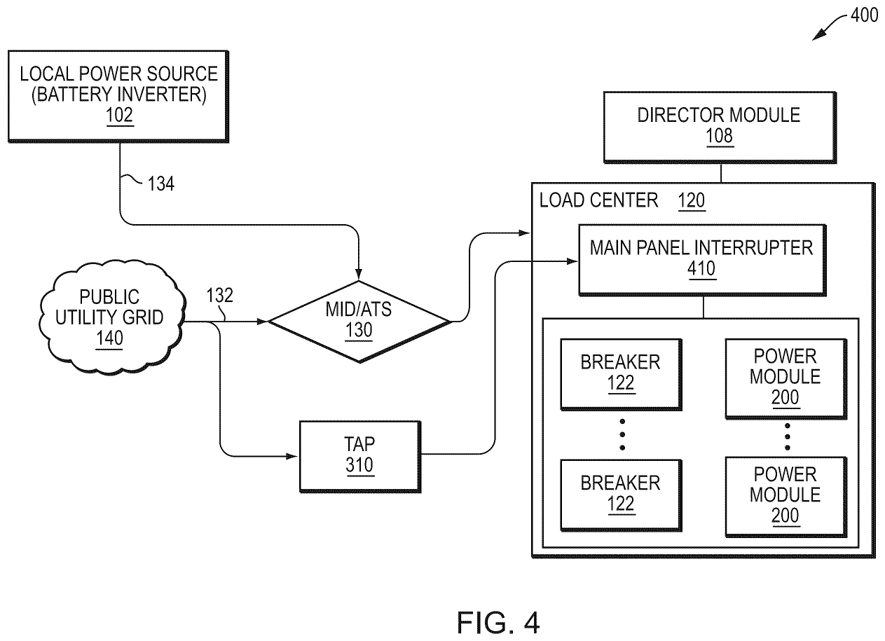

FIG. 4 illustrates an alternate exemplary deployment of the grid power loss detection technique within the FLM system.

### OVERVIEW

The embodiments described herein are directed to a technique configured to monitor and detect a loss of utility power supplied by a main utility grid so that power modules of a virtual critical load panel (vCLP) may shed non-critical loads substantially before (or soon after) a battery inverter switches to backup power. According to the technique, a grid detection module of the vCLP may be configured with profiles of industry standard power ranges (e.g., utility voltage or frequency ranges) utilized by a plurality (i.e., variety) of different battery inverters to monitor and detect the loss of the utility power as an indication to switch to the backup power. Notably, the grid detection module is configured with a profile specific to an inverter installed at a premises. The grid detection module employs the profile in a manner that not only enables monitoring and detection of the loss of utility power but provides sufficient advanced timing ahead of expected utility power loss to enable shedding of the non-critical loads of the vCLP earlier than the switch to the backup power by the inverters to thereby prevent overload of the backup power while seamlessly (i.e., continuously) maintaining power to critical loads. That is, the grid detection module effectively emulates the inverter detection of the utility power loss so that the power modules can be signaled to shed non-critical loads before an overload breaker in the inverter trips.

In an embodiment, the grid detection module is coupled to a tap on power supply lines of the utility grid (e.g., via a fused connection to a main breaker in-line to the power supply line) to sample the utility power and check whether the sampled power breaches a threshold of a specified power range (e.g., supplied utility voltage) according to the configured profile that emulates switchover behavior of the battery inverter independently monitoring the power supply line. If the supplied utility power breaches the specified power range, the grid detection module signals the power modules of the vCLP to enter a critical load mode and shed their non-critical loads expecting (i.e., predicting) that the battery inverter will also detect the breach of the specified power range and switchover shortly (milliseconds) thereafter.

Advantageously, the grid detection module and power modules of the vCLP may cooperate to expeditiously and predictively detect a grid outage via the grid detection module and shed non-critical loads using the power module notified by the grid detection module without overloading the battery inverter. Moreover, the grid detection module and power modules operate autonomously from the battery inverter to detect grid outage and shed the non-critical loads without reliance on grid state received from the battery inverter, i.e., without communication with the battery inverter.

### DESCRIPTION

FIG. 1 illustrates an exemplary deployment of a flexible load management (FLM) system 100 within a premise, such as a place of business or home. The FLM system 100 employs one or more virtual critical load panels (vCLPs), each of which provides a prioritization of loads that are considered sufficiently important to warrant protection by a secondary (local) power source 102 of the premise as a failover and/or to supplement power availability. As described herein, the FLM system 100 utilizes circuit interrupts or breakers 122 in combination with power modules 200 (i.e., intelligent controllers) to shed non-critical loads substantially close to (before) a failover time for switching to backup power provided by the local power source 102.

In one or more embodiments, the local power source 102 for the premise is a battery inverter which converts direct current (DC) from a battery to alternating current (AC) of high voltage. Illustratively, the local power source 102 is configured to generate substantial power, e.g., in a range of 5 kilowatts (kW) to 30 kW, sufficient to power numerous and different types of loads.

A host 106 is configured to manage power consumption and/or other high-level control functions in the FLM 100, e.g., determining which loads shall be activated (powered). To that end, the host 106 may include a processor configured to execute software and manipulate data structures maintained in a memory (e.g., a persistent or volatile memory) having locations for storing the software and the data structures. The data structures may include a state center, which may utilize states of components/devices in the FLM system 100 to describe the configuration of the components/devices, as well as to maintain other types of information. The host 106 may also include interfaces containing mechanical, electrical and signaling circuitry needed to connect and communicate with those components/devices. In an embodiment, the host 106 may be implemented based on a host commercially available from Savant Systems, LLC.

A panel bridge controller (PBC) 108 connects to the host 106 via a local area network (LAN) 110, such as Ethernet. The PBC 108 is configured to convert commands received over the LAN 110 from the host 106 to messages provided to a load center 120 over a wireless LAN (WLAN) 112 in accordance with a wireless messaging protocol, such as Bluetooth®, Zigbee®, Z-wave® or the like. The commands received over the LAN 110 and WLAN 112 from the host 106 are configured to control the power modules 200 of the load center 120. As described further herein, a power module 200 monitors (senses) voltage and current (power) of a load and wirelessly communicates (via Bluetooth or Zigbee) to the PBC 108 to enable remote control of the power module from a mobile application (e.g., executing on a mobile device of a user).

The load center 120 may include one or more electrical panels that, during normal operation, is provided with, e.g., 200 ampere (amp) service from a public utility grid 140. In an embodiment, the load center 120 is configured to receive power over power feed 136 from the grid 140 via a main power feed 132 and an automatic transfer switch or micro-grid interconnection device (MID/ATS) 130 (having a transfer time to switch to power supplied from the local power source), and distribute the power (i.e., current) to branch circuits of the premises via the circuit breaker 122 enclosed in the electrical panel. Illustratively, the electrical panel is embodied as a vCLP 125 by the inclusion of power modules 200 hardwired (e.g., in series) with the circuit breakers 122 to control activation/deactivation of a respective circuit breaker. The power modules 200 and associated circuit breakers 122 may be located in separate electrical boxes (e.g., a main electrical panel and a power module panel) within the load center 120.

In an embodiment, the MID/ATS 130 is an intelligent power switching device having a microprocessor-based controller configured to automatically disconnect from the main power feed 132 of the public utility grid 140 and connect to a local power feed 134 of the local power source 102 when power from the public utility grid 140 goes down (i.e., power fails or becomes unavailable). Illustratively, the MID/ATS 130 includes a low voltage control (contact) in communication with the local power source 102 that is configured to initiate (trigger) starting of the local power source 102 in the absence of power from the public utility grid 140. When power from the public utility grid 140 subsides (terminates), the host signals the MID/ATS via control 135 to start the local power source 102 during a transfer time (not shown). Power is then provided over the local power feed 134, through the MID/ATS 130 and over the power feed 136 to the load center 120.

A grid voltage transformer (VT) 142 is configured to monitor the public utility grid voltage (e.g., via a voltage monitoring branch circuit) to determine when the voltage sufficiently subsides (e.g., near a zero-crossing) so that it is safe to turn-on (activate) the local power source 102. In an embodiment, the grid VT 142 converts and isolates utility line voltage, e.g., 240V, to a low voltage suitable for digital sampling. A panel VT 146 is a voltage transformer configured to monitor voltage provided to the load center 120. In an embodiment, the FLM system 100 may also include one or more current transformers (CTs) configured to monitor current from the public utility grid 140 that is provided to the load center 120.

A smart energy monitor (SEM) 144 is configured to monitor (measure) the voltages and currents from the transformers, as well as from other loads (such as air conditioners) in the premises. Illustratively, the SEM 144 is embodied as an analog-to-digital (A-D) converter that collects and samples the voltages/currents from the VTs/CTs. The voltages and currents are preferably sampled at a high data rate (e.g., 1 kHz) by the SEM 144, which performs operations (i.e., computations) directed to, e.g., power factor, apparent/real power, etc., for power management calculations. The sampled data is then provided to the host 106 over control and data signal lines 148 to determine a power capacity level of the FLM system, in accordance with the embodiments described herein.

FIG. 2 is a block diagram of a power module 200. In an embodiment, the power module operates to support, e.g., turn on (and off), one or more relays, e.g., one 30A/240 VAC circuit or, illustratively, two 15A/120 VAC circuits. A power measurement digital signal processor (DSP) 202 is coupled to a breaker controller 204 having a processor with onboard wireless (Bluetooth) transceiver. The power measurement DSP 202 is also coupled to voltage sense lines 206 and current sense lines 208. As described further herein, the breaker controller 204 includes a memory 225, e.g., RAM and/or Flash.

A pair of relays 210 is coupled, respectively, between a pair of screw terminals 212 and a pair of current (e.g., Hall Effect) sensors 214. The relays 210 are normally-open (NO) to conduct power to a branch circuit and are coupled to each of the pair of screw terminals 212 that serves as a connection point to a conventional 15A/120 VAC circuit breaker 122, such as an arc fault breaker, which is manually capable of being actuated. Alternatively, each relay 210 may be embodied as an actuated mechanical switch to obviate the need of the conventional circuit breaker while providing for adequate safety. Each of a pair of screw terminals 216 serves as a connection point to a desired load (not shown). An AC-to-DC power supply 218 outputs+12 VDC and +3.3 VDC to power the power module 200. As an alternative to using power measurement DSP 202 to output pulses when the sensed voltage and current are near zero, a zero cross detector circuit 220 may be used to generate a square wave output signal which is coupled to the breaker controller 204 over line 222.

In an embodiment, power measurement DSP 202 is capable of calculating, among other values, instantaneous power consumption separately for each load connected to screw terminals 216, as well as average power consumption over a specified period of time, and peak power consumption. Power measurement DSP 202 may also be configured to output pulses over lines 205 to breaker controller 204 when the current and voltage are near zero. By knowing when zero crossings of current and voltage are occurring, breaker controller 204 ensures that relays 210 are only switched (i.e., opened or closed) contemporaneously with the occurrence of one or more zero crossings. This advantageously reduces arcing and tends to prolong the service lives of relays 210.

Operationally, the power modules 200 are configured to turn on (and off) loads to ensure a proper amount of power for the loads in the premise that is supportable by a local power source 102 (e.g., a battery inverter) according to the prioritization of the loads provided by vCLP. In other words, the power modules 200 are virtually wired (and commanded) to turn on and off (activate/deactivate) based on prioritization. Notably, the power modules of the vCLP 125 may be configured by a user via a mobile application executing on a mobile device (not shown). After installation by an electrician, the mobile application can be invoked to configure a “bucket” of virtual critical loads (vCLs) supportable by the local power source 102 until a limit of supportable loads is reached. To change (i.e., add) loads to the vCL bucket, the user needs to remove other loads from the bucket. This allows the user to change critical loads via the mobile application, which is an improvement from previous critical load panel approaches that hardwired the critical loads, which hardwired loads could not be easily changed.

However, previous deployments of power modules 200 included back-up power provided by an uninterrupted power supply (UPS) unit to power the power modules when the public utility grid fails. When power was lost, load shedding adjustments by the power modules could be performed via immediate switching to UPS power for the modules. The FLM system eliminates the need for the UPS unit, thereby reducing cost, improving reliability and reducing complexity of a UPS powered controller to message/configure the power modules upon main power loss (thus avoiding the local power source having an overload condition and down time upon main power loss) by allowing performance of the load adjustments while the MID/ATS transfers power supplied from the local power source (e.g., during the transfer time).

The embodiments described herein are directed to a technique configured to monitor and detect an imminent loss of utility (AC) power supplied by a main (public) utility grid so that power modules of virtual critical load panel (vCLP) may be signaled to shed non-critical loads substantially close to (before or soon after) the time a battery inverter switches to backup power. According to the technique, a grid detection module of the vCLP may be configured (e.g., programmed via a firmware update) with profiles according to industry standard (e.g., IEEE Standard 1547 for Interconnecting Distributed Resources with Electric Power Systems) prescribed power (e.g., voltage or frequency) settings and ranges utilized by a plurality (i.e., variety) of different battery inverters to monitor and detect the loss of the utility power as an indication to switch to the backup power, wherein the grid detection module is configured with a profile specific to the inverter installed at the premises. Note that the technique is not directed to merely under- or over-voltage reactive power assistance during utility power anomalies, but rather detection of utility grid failure. The grid detection module employs the profiles in a manner that not only enables monitoring and detection of the loss of utility power but provides sufficient advanced timing ahead of expected utility power loss to enable shedding of the non-critical loads of the vCLP earlier than the switch to the backup power by the inverters to thereby prevent overload of the backup power while seamlessly (i.e., continuously) maintaining power to critical loads. That is, the grid detection module effectively emulates (using the profiles) the inverter detection of the utility power loss so that the power modules can be signaled to shed non-critical loads before an overload breaker (not shown) in the inverter trips.

FIG. 3 illustrates an exemplary deployment of a grid power loss detection technique 300 within a FLM system. In an embodiment, the grid detection module 300 is illustratively a power module that is dimensioned and sized for insertion into a slot of the vCLP 125 (i.e., a load center) and is configured with firmware different from that of the power modules. The grid detection module 310 is coupled (wired) to a 2-pole breaker illustratively embodied as a tap and fuse box (“tap 310”) that, in turn, is connected to power supply lines of the main power feed 132 of the public utility grid 140. The grid detection module 310 is configured to sample (using e.g., the processor of breaker controller 204 operating at a 8 KHz/125 microsecond sampling rate/interval) the utility power (e.g., voltage) and check whether the sampled voltage breaches a threshold of the specified power range (e.g., supplied utility voltage or frequency) according to the configured profile that emulates switchover behavior of the battery inverter 102 independently monitoring the power supply line. Although the profile employed by the grid detection module 310 specifies the same power range monitored by the battery inverter 102, the grid detection module 310 may be further programmed to slightly modify (e.g., shorten detection time of) the voltage range from the prescribed settings to substantially guarantee that the power modules 200 (e.g., embodied as companion modules) shed their non-critical loads just prior to (ahead of) or soon after the battery inverter 102 switching to backup power. That is, the grid detection module is programmed with a modified profile configured to predict some short time (i.e., a time period) in advance (milliseconds) of when the battery inverter will detect the breach of the specified power range (i.e., detect the utility grid power failure) and switchover shortly thereafter. In an embodiment, the short time period to predict in advance when the battery inverter will detect breach is configured to permit signaling and switching of the power modules to shed (i.e., disconnect) power from non-critical loads.

If the supplied utility power breaches (falls out of) the specified range according to the modified profile (e.g., causing a grid outage event), the grid detection module 310 registers a grid outage event. In an embodiment, the grid outage event is defined by preset thresholds according to industry standards, such as IEEE Standard 1547-2003 for Grid Disconnect Settings (e.g., the voltage dropping to zero for at least 40 msecs corresponding to the modified profile being breached for 40 msecs). The grid detection module 310 then signals the power modules 200 of the vCLP 125 (e.g., via a wireless Bluetooth broadcast message, Zigbee messages, WiFi messages/signal or wired signal) to enter a critical load mode and shed their non-critical loads. In an embodiment, the PBC 108 (e.g., illustratively embodied as a director module) is configured to determine whether the shedding of loads was premature (e.g., too early) or whether the detection of grid power loss by the grid detection module 310 was accidental (e.g., a false positive such as during a short duration utility over- or under-power condition). If so, the director module 108 communicates with the power modules to override the decision to enter the critical load mode and instruct the power modules 200 to reenter normal mode to re-power or not disconnect non-critical loads.

In an alternate embodiment, the technique may monitor and detect the loss of utility power supplied by the main utility grid using an intelligent main panel interrupter of the vCLP 125 that is configured with a profile to detect grid power loss and disconnect the utility power from the vCLP. FIG. 4 illustrates an alternate exemplary deployment of the grid power loss detection technique 400 within the FLM system. In this embodiment, the main panel interrupter 410 is coupled to (interfaces with) the tap 310 connected to the power supply lines of the utility grid 140 and configured to sense a state of the utility power. According to the technique, the main panel interrupter 410 is illustratively a 200 or 400 amp contactor that may be configured (e.g., programmed via a firmware update) with profiles of industry standard (e.g., IEEE Standard 1547) prescribed power (e.g., voltage and/or frequency) settings and ranges utilized by the battery inverter 102 to monitor and detect the loss of the utility power as an indication to switch to the backup power. In this embodiment, the power modules 200 are configured to detect a number of missing zero (voltage and/or current) crossings of the supplied utility power. If the state of the utility power breaches (falls out of) the specified range, the main panel interrupter 410 disconnects or “cuts” the power (e.g., by opening contacts to create an air gap) for a short period of time (e.g., 50 msecs) sufficient for the number of zero crossings of the utility grid power frequency before closing the contacts. In response, the power modules 200 sense the missing zero crossings and shed their non-critical loads. In this manner, a lack of power for the number of zero crossings is used to effectively signal the power modules to shed non-critical loads.

Advantageously, the grid detection module 310, main panel interrupter 410, and power modules 200 of the vCLP may cooperate to expeditiously and predictively detect a grid outage and shed non-critical loads using the power module notified by the grid detection module without overloading the battery inverter 102. Moreover, the grid detection module 310, main panel interrupter 410, and power modules 200 operate autonomously from the battery inverter to detect grid outage and shed the non-critical loads without reliance on any grid state information received from the inverter, i.e., without communication with the battery inverter 102.

The foregoing description has been directed to specific embodiments of this invention. It will be apparent, however, that other variations and modifications may be made to the described embodiments, with the attainment of some or all of their advantages. For example, it is expressly contemplated that the teachings of this invention can be implemented as software, including a computer-readable medium having program instructions executing on a computer, hardware, firmware, or a combination thereof. Accordingly, this description is to be taken only by way of example and not to otherwise limit the scope of the invention. It is thus the object of the appended claims to cover all such variations and modifications as come within the true spirit and scope of the invention.

1. An apparatus comprising:
a micro-grid interconnection device or automated transfer switch (MID/ATS) configured to disconnect primary electrical power supplied by a primary power source and supply secondary electrical power when the primary electrical power fails;
a secondary electrical power source connected to an inverter configured to detect failure of primary electrical power and supply the secondary electrical power when failure of the primary electrical power is detected;
one or more power modules installed in a load center and connected to the MID/ATS, each power module controlling electrical power to a respective branch circuit of the load center; and
a grid detection module connected to the primary power source and configured to predict when the inverter detects failure of the primary electrical power, wherein the grid detection module is configured to signal the power modules to turn-off non-critical loads before or soon after the inverter supplies the secondary electrical power when the inverter is predicted to detect failure of the primary electrical power.

2. The apparatus of claim 1, wherein the grid detection module is programmable according to a profile emulating when the inverter detects failure of the primary electrical power.

3. The apparatus of claim 2, wherein the profile is modified to predict a time period in advance of when the inverter detects failure of the primary electrical power.

4. The apparatus of claim 3, wherein the time period is configured to permit signaling and switching of the power modules to shed power from non-critical loads.

5. The apparatus of claim 3, wherein the prediction to detect failure of the primary electrical power by the grid detection module is configured to respond to the detected breach of the one of specified voltage or frequency range for the time period.

6. The apparatus of claim 1, wherein the grid detection module configured to predict when the inverter detects failure of the primary electrical power is further configured to detect a breach of one of a specified voltage or frequency range for the primary electrical power.

7. The apparatus of claim 1, wherein the grid detection module configured to predict when the inverter detects failure of the primary electrical power is without reliance on grid state information received from the inverter.

8. The apparatus of claim 1, wherein the grid detection module is a power module configured with firmware different from that of the power modules, wherein the power modules and grid detection module are dimensioned and configured to fit into a slot of the load center.

9. A method of controlling electrical power to branch circuits of a load center having power modules installed therein, each power module controlling the electrical power to a respective branch circuit during transfer of supplying primary electrical power from a primary electrical power source to supplying secondary electrical power from a secondary electrical power source when the primary electrical power fails, the secondary electrical power source connected to an inverter configured to detect failure of the primary electrical power and supply the secondary electrical power when failure of the primary electrical power is detected, the method comprising:
predicting when the inverter detects failure of the primary electrical power using a grid detection module connected to the primary power source; and
signaling the power modules to turn-off non-critical loads before or soon after the inverter supplies the secondary electrical power when the inverter is predicted to detect failure of the primary electrical power.

10. The method of claim 9, further comprising programming the grid detection module according to a profile emulating when the inverter detects failure of the primary electrical power.

11. The method of claim 10, further comprising modifying the profile to predict a time period in advance of when the inverter detects failure of the primary electrical power.

12. The method of claim 11, wherein the time period is configured to permit signaling and switching of the power modules to shed power from non-critical loads.

13. The method of claim 9, wherein predicting when the inverter detects failure of the primary electrical power is without reliance on grid state information received from the inverter.

14. The method of claim 9, wherein predicting when the inverter detects failure of the primary electrical power further comprises detecting a breach of one of a specified voltage or frequency range for the primary electrical power.

15. The method of claim 9, wherein the grid detection module is a power module configured with firmware different from that of the power modules, and wherein the power modules and grid detection module are dimensioned and configured to fit into a slot of the load center.

16. An apparatus comprising:
a micro-grid interconnection device or automated transfer switch (MID/ATS) configured to disconnect primary electrical power supplied by a primary power source and supply secondary electrical power when the primary electrical power fails;
a secondary electrical power source connected to an inverter configured to detect failure of primary electrical power and supply the secondary electrical power when failure of the primary electrical power is detected;
one or more power modules installed in a load center and connected to the MID/ATS, each power module controlling electrical power to a respective branch circuit of the load center; and
a load panel interrupter adapted to control power to the load center wherein, in response to the detection of failure of the primary electrical power, the load panel interrupter disconnects power for a period of time to the load center to signal the power modules to turn-off non-critical loads before or soon after the inverter supplies the secondary electrical power when the inverter is predicted to detect failure of the primary electrical power.

17. The apparatus of claim 16, wherein the load panel interrupter is programmable according to a profile emulating when the inverter detects failure of the primary electrical power.

18. The apparatus of claim 16, wherein power modules are configured to detect a number of missing zero crossings for the period of time as the signal to turn-off non-critical loads.

19. The apparatus of claim 16, wherein the load panel interrupter is a contactor configured with profiles of prescribed power settings and ranges utilized by the inverter to monitor and detect the loss of the primary electrical power as an indication to supply the secondary electrical power.

20. The apparatus of claim 16 wherein, in response to a state of the primary electrical power breaching a prescribed power range, the load panel interrupter disconnects the power by opening contacts to create an air gap for the period of time.
